(19) United States
(12) Patent Application Publication
(10) Pub. No.: US 2010/0272884 A1
(43) Pub. Date: Oct. 28, 2010

(54) SOLDER BALL PRINTING APPARATUS AND SOLDER BALL PRINTING METHOD

(75) Inventors: Akio IGARASHI, Tokyo (JP); Noriaki Mukai, Tokyo (JP); Makoto Honma, Tokyo (JP); Naoaki Hashimoto, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Plant Technologies, Ltd.

(21) Appl. No.: 12/765,129

(22) Filed: Apr. 22, 2010

(30) Foreign Application Priority Data
Apr. 23, 2009 (JP) 2009-104845

(51) Int. Cl. B05D 5/12; B05C 5/00

(52) U.S. Cl. 427/126.1; 118/301

(57) ABSTRACT

The present invention provides a solder ball printing apparatus and a solder ball printing method in which solder balls are uniformly dispersed on a mask surface and are loaded into an opening area of the mask.

A solder ball shaking and discharging unit includes a solder ball feeding unit which receives solder balls from a solder ball reservoir unit, a wire member in a convex shape which is attached so as to surround a solder ball shaking and discharging port of the solder ball feeding unit and in which a plurality of wire members are arranged at predetermined intervals, and solder ball loading members, each of which is arranged in the front and rear of the wire member in a convex shape to load the solder balls into an opening area of a mask.

### BACKGROUND OF THE INVENTION

(1) Field of the Invention

The present invention relates to a printing apparatus for forming solder balls on an electrode of a substrate such as a semiconductor by a printing method, and particularly to a solder ball printing apparatus and a solder ball printing method for printing using solder balls.

(2) Description of the Related Art

In a conventional solder ball printing apparatus, there have been proposed various configurations in which a mask used for printing solder balls is placed on a substrate such as a semiconductor, the solder balls are fed onto a mask surface, and the fed solder balls are pressed from an opening area provided at the mask into a surface of the substrate such as a semiconductor.

As described in, for example, Japanese Patent Application Laid-Open No. 2005-101502, there is disclosed a printing apparatus configured in such a manner that a solder ball feeding unit for feeding solder balls onto a mask surface and a plurality of wire members provided at a sieve are moved in the horizontal direction while being pressed into the mask surface in order to press the solder balls fed onto the mask surface into a surface of a substrate from an opening area provided at the mask.

In the printing apparatus, it is described that at a left end of the mask, there is provided a solder ball sucking port where the solder balls remaining on the mask surface are sucked and removed.

Further, Japanese Patent Application Laid-Open No. 2008-142775 discloses that when solder balls are squeezed into an opening area of a mask by moving a squeegee head in the horizontal direction while rotating the same, a predetermined amount of solder balls is fed to a rotational shaft portion of the squeegee head from a measuring unit provided at an upper portion of the squeegee head, and the solder balls are fed from the rotational shaft onto a mask surface.

In the configuration of Japanese Patent Application Laid-Open No. 2005-101502, when the mask is placed on a table, a solder ball feeding apparatus is disposed at an inlet port to which the mask is carried, and the mask is moved on the mask while feeding the solder balls onto the mask surface from the solder ball feeding apparatus.

Accordingly, the solder balls are uniformly dispersed and arranged on the mask surface. Thereafter, the sieve is moved in the horizontal direction, and the solder balls are fed into the opening area of the mask. When the solder balls are dispersed and arranged on the mask in this method, there is a risk that the dispersed and arranged solder balls vary in amount due to fluctuations caused when the mask is moved and oscillation when the movement of the mask stops.

Further, since the solder balls are fed before the mask is set in the printing apparatus, it is necessary to move the mask for each printing process, resulting in the problem of a long tact time.

Further, solder balls unused in printing are sucked through the sucking port provided separately from a solder ball feeding head. In this case, when the extra solder ball can not be held by the first wire member of the sieve in a wire shape, the extra solder ball is held by the subsequent wire member to be carried near the sucking port. However, there is a possibility that the solder ball held by the subsequent wire member and the solder ball which is previously fed are fed to an opening area of the mask at the same time.

In the method of feeding the solder balls onto the mask surface from the rotational shaft portion as disclosed in Japanese Patent Application Laid-Open No. 2008-142775, the solder balls are dispersed and arranged on the mask surface along with the rotation of the squeegee head. Accordingly, the solder balls can not be always uniformly dispersed and arranged, and printing defects are generated. Thus, a repairing step is essential.

As described above, when the solder balls are dispersed and arranged on the mask, there is a risk that the dispersed and arranged solder balls vary in amount due to fluctuations caused when the mask is moved and oscillation when the movement of the mask stops. In addition, since the solder balls are dispersed and arranged on the mask surface along with the rotation of the squeegee head, the solder balls can not be uniformly dispersed and arranged. Thus, there are problems in aspects of the configuration of the apparatus and printing methods.

Accordingly, a first object of the present invention is to provide a solder ball printing apparatus and a solder ball printing method for uniformly printing solder balls with a high degree of accuracy.

A second object of the present invention is to provide a solder ball printing apparatus and a solder ball printing method for shortening a tact time in solder ball printing.

A third object of the present invention is to provide a small-sized solder ball printing apparatus with a simple configuration and a solder ball printing method.

A fourth object of the present invention is to provide a solder ball printing apparatus and a solder ball printing method in which solder balls unloaded into an opening area of a mask by loading members are collected for reuse.

A fifth object of the present invention is to provide a solder ball printing apparatus and a solder ball printing method in which when solder balls are fed to a solder ball feeding unit from a solder ball reservoir unit, the solder balls are reliably fed to the solder ball feeding unit while preventing the solder balls from being spread around.

A sixth object of the present invention is to provide a solder ball printing apparatus and a solder ball printing method which reduces a period of time when solder balls are exposed to the atmosphere to prevent the solder balls from being oxidized.

### SUMMARY OF THE INVENTION

The present invention provides a solder ball printing apparatus which prints solder balls on a substrate and an electrode on the substrate through a mask, the apparatus including: a solder ball reservoir unit which reserves the solder balls; a solder ball shaking and discharging unit which is located under the solder ball reservoir unit, receives a predetermined amount of solder balls from the solder ball reservoir unit, and feeds the received solder balls onto a surface of the mask located on the substrate; a moving mechanical unit which moves the solder ball shaking and discharging unit along the substrate; and an oscillation unit which applies predetermined oscillation to the solder ball shaking and discharging unit, wherein the solder ball shaking and discharging unit includes a solder ball feeding unit for receiving the solder balls from the solder ball reservoir unit, a wire member in a convex shape which is attached so as to surround a solder ball shaking and discharging port of the solder ball feeding unit and in which a plurality of wire members are arranged at predetermined intervals, and solder ball loading members, each of which is located in the front and rear of the wire member in a convex shape to load the solder balls into an opening area of the mask.

In the above configuration, the solder ball shaking and discharging unit further includes solder ball rotating and collecting mechanisms, each of which is located in the front and rear of the solder ball loading members and collects the solder balls which are dispersed without being loaded by the solder ball loading members near the solder ball loading members.

In the above configuration, the solder ball shaking and discharging unit is provided with a head outer wall so as to cover the solder ball feeding unit, the solder ball loading members, and the solder ball rotating and collecting mechanisms, and is formed as a sealing-type head structure.

In the above configuration, squeegee covers are further provided on the inner side of the head outer wall so as to cover the solder ball rotating and collecting mechanisms.

In the above configuration, the moving mechanical unit further includes a vertically-driving mechanism for vertically moving the solder ball shaking and discharging unit, applies pressing force to press the wire member in a convex shape and the solder ball loading members provided at the solder ball shaking and discharging unit to the surface of the mask with the vertically-driving mechanism, and allows the wire member in a convex shape and the solder ball loading members to be brought into contact with the surface of the mask with predetermined pressing force in the moving direction of the solder ball shaking and discharging unit.

In the above configuration, the wire member in a convex shape and wire members configuring the solder ball loading members are configured by the plurality of wire members at predetermined intervals, the wire member is a steel plate with a thickness of 0.05 to 0.1 mm and a width of 0.1 mm, the intervals of the wire members are 0.1 mm to 0.3 mm, and the wire members are provided while being inclined at angles of about 5 to 35 degrees relative to the direction orthogonal to the travelling direction of the solder ball shaking and discharging unit.

Further, in the above configuration, the plurality of wire members of the solder ball loading members provided at the solder ball shaking and discharging unit are provided in such a manner that the inclined directions thereof are opposed to each other.

In the above configuration, the solder ball printing apparatus further includes: a printing table for fixing the substrate; a camera with two upper and lower viewing fields for recognizing an electrode pattern on the substrate on the printing table and an electrode pattern of the mask; a driving apparatus which drives and aligns the printing table on the basis of the result recognized by the camera with two viewing fields; and a driving mechanism for lifting the printing table to allow the substrate to be brought into contact with the mask.

The present invention provides a solder ball printing method in a solder ball printing apparatus which prints solder balls retained in a solder ball reservoir unit on a substrate and an electrode on the substrate through a mask, the method including: a step of receiving a predetermined amount of solder balls from the solder ball reservoir unit and feeding the received solder balls onto a surface of the mask; a solder ball dispersing step of dispersing the solder balls fed from the solder ball reservoir unit into an opening area of the surface of the mask; a solder ball loading step of loading the solder balls dispersed in the solder ball dispersing step into the opening area of the surface of the mask; and a step of collecting the solder balls which are dispersed without being loaded in the solder ball loading step.

The present invention is advantageous in that the solder balls can be uniformly fed onto the mask, the solder balls can be fed by replacing the solder ball reservoir unit with another or by feeding the solder balls to the solder ball reservoir unit from outside while checking the amount of remaining solder balls in the solder ball reservoir unit, and it is not necessary to interrupt an operation due to the deficiency and excess of the solder balls.

Further, since the wire member in a semi-spiral shape or the solder ball loading members made of wire members in a convex shape provided at the solder ball shaking and discharging port is arranged, rotational force can be added to the solder balls by oscillation in a space formed by the wire member in a semi-spiral shape or the wire member in a convex shape. Thus, the solder balls can be uniformly dispersed and can be smoothly loaded even into the opening area of the mask. Further, since the extra solder balls remaining on the mask surface are collected for use in the loading head by the solder ball rotating and collecting mechanisms provided in the front and rear of the loading members, the solder balls can be effectively used.

### BRIEF DESCRIPTION OF THE DRAWINGS

FIG. 1 are diagrams, each showing a schematic configuration of an embodiment of a solder ball feeding head for a solder ball printing apparatus;

FIG. 2 are diagrams, each showing a schematic configuration of the solder ball printing apparatus for printing solder balls;

FIG. 3 are diagrams, each showing another embodiment of the solder ball feeding head for the solder ball printing apparatus;

FIG. 4 are diagrams, each showing an embodiment of a wire member in a semi-spiral shape used for a solder ball feeding unit;

FIG. 5 is a diagram for explaining an operation of loading the solder balls; and

FIG. 6 is a flowchart for showing an embodiment of a solder ball printing method.

### DETAILED DESCRIPTION OF THE EMBODIMENT

Hereinafter, the present invention will be described using the drawings. An embodiment described below is one aspect of the present invention, and can be amended and modified within a range where those skilled in the art can easily conceive.

### First Embodiment

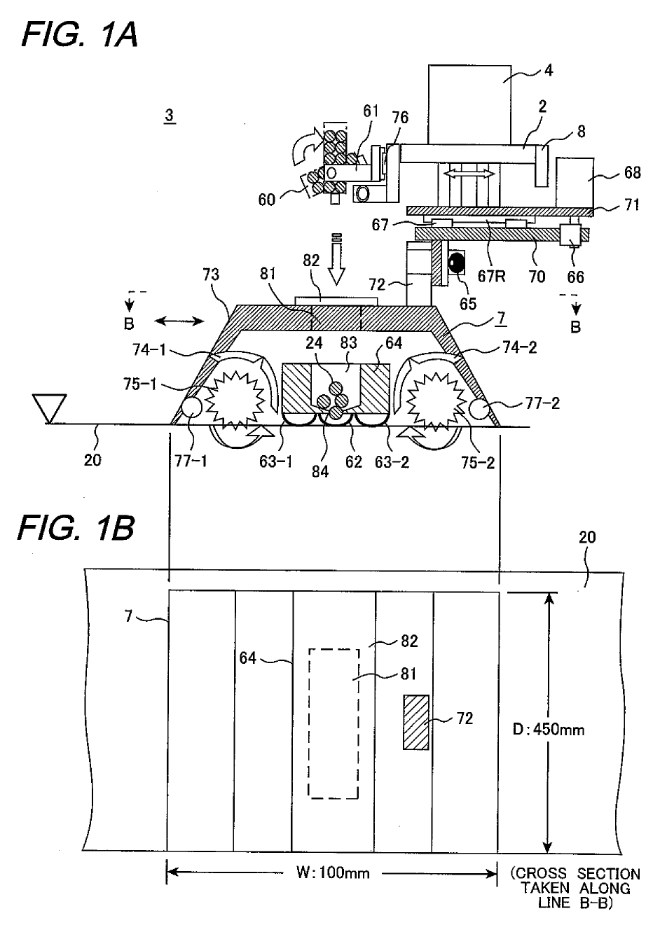

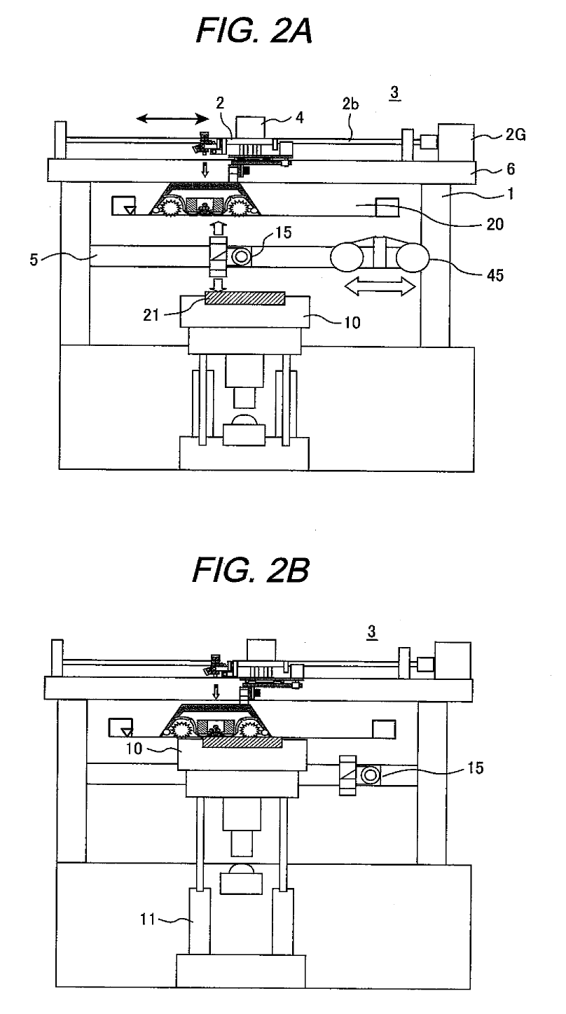

An embodiment of a solder ball printing apparatus according to the present invention will be described using FIG. 1 and FIG. 2. FIG. 1 are diagrams, each showing a schematic configuration of the embodiment of a solder ball feeding head for the solder ball printing apparatus of the present invention. FIG. 1A is a diagram for showing a schematic configuration of a side face of the solder ball feeding head for the solder ball printing apparatus according to the embodiment. FIG. 1B is a schematic plan view viewed from the line B-B in the solder ball feeding head for the solder ball printing apparatus of FIG. 1A. FIG. 2 are diagrams, each showing a schematic configuration of the embodiment of the solder ball printing apparatus in which a solder ball printing head is provided. FIG. 2A is a diagram for explaining a state in which a mask and a substrate are aligned, and FIG. 2B is a diagram for explaining a state in which solder balls are printed on the substrate.

In a solder ball printing apparatus 1 shown in FIG. 2, a solder ball feeding head 3 is movably attached to an attachment frame 6 and a ball screw 2b of the solder ball printing apparatus 1 through a head moving table 2. The solder ball feeding head 3 is configured in such a manner that the ball screw 2b is rotated by control of a motor 2g and the solder ball feeding head 3 is moved in the arrow directions. It should be noted that the details of the solder ball printing apparatus 1 will be described later.

In the first place, an embodiment of the solder ball feeding head 3 will be described using FIG. 1. In FIG. 1A, the solder ball feeding head 3 includes a solder ball shaking and discharging unit 7, a moving mechanical unit 8 for moving the solder ball shaking and discharging unit 7, and a connection member 72 for connecting the solder ball shaking and discharging unit 7 and the moving mechanical unit 8.

The solder ball shaking and discharging unit 7 includes a solder ball feeding unit 64 which feeds solder balls 24 onto a mask 20, a head outer wall 73 provided so as to cover the solder ball feeding unit 64, solder ball rotating and collecting mechanisms (rotational squeegee) 75-1 and 75-2, squeegee covers 74-1 and 74-2 which cover outer circumferences of the solder ball rotating and collecting mechanisms 75, nitrogen gas feeding ports 77-1 and 77-2, a wire member 62 in a semi-spiral shape or a convex shape (to be described later) which feeds an appropriate amount of the solder balls 24 onto the mask 20, and solder ball loading members 63-1 and 63-2 (to be described later) which load the solder balls 24 into an opening area of the mask 20.

The solder ball feeding unit 64 is attached and fixed on the inner side of both ends of the head outer wall 73. An opening area 81 is provided at a portion of the head outer wall 73 corresponding to an opening area 83 of the solder ball feeding unit 64, so that the solder balls 24 can be fed to the solder ball feeding unit 64 from a solder ball reservoir unit (to be described later). It should be noted that it is necessary to maintain the inside of the head outer wall 73 in a sealed state so as to be filled with a nitrogen gas as will be described later. Thus, an opening and closing cover 82 is provided at the opening area 81 of the head outer wall 73, and the inside of the head outer wall 73 is sealed by the opening and closing cover 82 except when the solder balls 24 are fed to the solder ball feeding unit 64.

Next, the moving mechanical unit 8 will be described. The moving mechanical unit 8 includes a head attachment frame 71 attached to the connection member 72, the head moving table 2, a head vertically-moving mechanism 4, a solder ball feeding table 61 coupled to the head moving table 2, and a solder ball reservoir unit 60. The head vertically-moving mechanism 4 includes cylinders and pistons, and is attached to the head moving table 2. The head attachment frame 71 is attached to piston shafts of the head vertically-moving mechanism 4. Accordingly, the vertical movement of the piston shafts allows the solder ball shaking and discharging unit 7 connected to the head attachment frame 71 through the connection member 72 to be vertically moved. The piston shafts are moved downward when the solder ball shaking and discharging unit 7 is brought into contact with the mask 20 to print the solder balls on the substrate through the mask 20, and are moved upward when the solder ball shaking and discharging unit 7 is returned to its original position (for example, home position) after completion of the print. Further, the head moving table 2 is connected to the ball screw portion of a horizontally-moving mechanism including the motor 2g and the ball screw 2b provided on the side of the main body of the apparatus as described above, and is moved in the horizontal direction by driving the motor 2g.

Further, the solder ball feeding table 61 to which the solder ball reservoir unit 60 is attached is provided at the head moving table 2. The solder ball reservoir unit 60 is attached to the solder ball feeding table 61 so as to be rotated in the arrow direction. In addition, the solder ball reservoir unit 60 can be vertically moved by a linear driving unit 76. When the solder balls 24 are fed to the solder ball shaking and discharging unit 7, the solder ball reservoir unit 60 is moved downward and is rotated to allow an opening area of the solder ball reservoir unit 60 to face downward. Accordingly, the solder balls 24 can be shaken and dropped into the solder ball feeding unit 64 from the inside of a container (cylinder) configuring the solder ball reservoir unit 60 through the opening area 81 of the head outer wall 73 and the opening area 83 provided at an upper portion of the solder ball feeding unit 64.

In more detail, the solder ball feeding unit 64 for feeding the solder balls 24 shaken and dropped from the solder ball reservoir unit 60 to the inside of the solder ball feeding unit 64 is disposed substantially under the solder ball reservoir unit 60. It should be noted that the positional relations of the surface of the mask 20, the solder ball shaking and discharging unit 7, the solder ball feeding unit 64, the opening area 81 and the opening and closing cover 82 of the head outer wall 73 of the solder ball shaking and discharging unit 7, and the connection member 72 are shown as in the plan view of FIG. 1B.

Further, the solder balls used in one printing process are initially and preliminarily fed to the solder ball feeding unit 64. Specifically, the solder ball shaking and discharging unit 7 is moved in the arrow direction as shown in FIG. 1A to shake and discharge the solder balls 24 onto the mask 20 in accordance with the movement. For example, if the movement of the solder ball feeding head 3 from the right end to the left end is assumed as one stroke in the solder ball printing apparatus of FIG. 2, it is necessary to feed the solder balls 24 enough to be fed onto the mask 20 in one stroke to the solder ball feeding unit 64. This corresponds to, for example, solder ball feeding for one printing process. Accordingly, during one printing process, namely, one stroke, the opening and closing cover 82 is closed to seal the inside of the head outer wall 73. In addition, the inside of the head outer wall 73 is filled with a nitrogen gas to prevent the solder balls 24 from being oxidized. Thus, the solder balls used in one printing process mean the amount of solder balls necessary in one stroke when the solder balls are fed onto the surface of the mask, and mean that the solder balls are fed to the solder ball feeding unit by preliminarily estimating the amount. However, it is difficult to accurately estimate the amount. Accordingly, it is obvious that when the amount of solder balls is not enough, the solder balls corresponding to the deficiency are appropriately refilled from the solder ball reservoir unit 60, and when the amount of solder balls is large, the extra solder balls are collected.

Further, although not shown in the drawing, the solder ball feeding table 61 can be moved in the direction orthogonal to the moving directions of the solder ball feeding head 3, and the solder balls 24 are fed to the solder ball feeding unit 64 while moving the solder ball reservoir unit 60. As an example, the head outer wall 73 has a width W of 100 mm and a length (depth) D of 450 mm as shown in FIG. 1B, although the size differs depending on a substrate as a printing target. Further, the size of the solder ball feeding unit 64 is formed to be substantially equal to or slightly shorter than the width (in the direction orthogonal to the travelling directions of the head) of the mask 20.

It should be noted in the embodiment that the diameter of the solder ball to be printed is substantially equal to the size of the opening area of the mask, and the solder ball with a diameter of 20 μm to 80 μm can be used. For example, if the opening area of the mask 20 is 50 μm in size, the solder ball with a diameter slightly smaller than 50 μm is used for printing. It should be noted in the embodiment that the embodiment will be described using the solder ball with a diameter of 20 μm to 80 μm, but it is obvious that the present invention is not limited thereto.

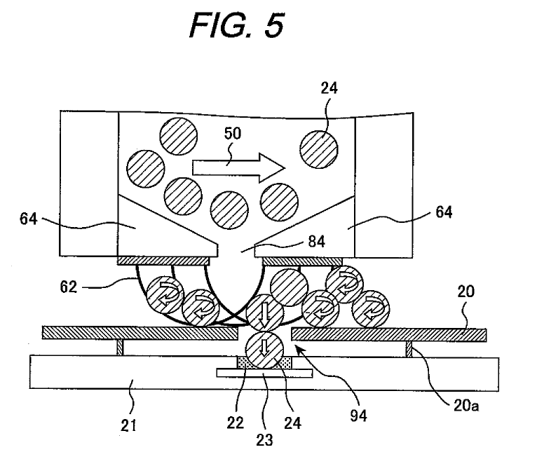

Further, an opening area 94 of the mask shown in FIG. 5 to be described later is slightly larger than the diameter of the solder ball 24 so as to fit the solder ball 24. In addition, the size of a solder ball shaking and discharging port 84 is substantially equal to that of the opening area 94 of the mask, and is slightly larger than that of the solder ball 24, which prevents an excessive amount of solder balls 24 from being discharged from the solder ball shaking and feeding port 84 at a time.

Further, the solder ball loading members 63-1 and 63-2 (to be described later) for loading the solder balls 24 into the opening area of the mask 20 are provided in the front and rear directions (the front and rear directions in the travelling directions of the head) of the wire member 62 in a semi-spiral shape or a convex shape provided near the solder ball shaking and discharging port 84 of the solder ball feeding unit 64. It should be noted that the solder ball loading members 63-1 and 63-2 are collectively referred to as solder ball loading members 63 in some cases. The solder ball loading members 63 are formed of a wire member same as the wire member 62 in shape provided near the solder ball shaking and discharging port 84 of the solder ball feeding unit 64.

Here, the solder ball shaking and discharging unit 7 will be described in more detail. The solder ball shaking and discharging unit 7 has an oscillation structure in which predetermined oscillation is applied so as to substantially uniformly shake and discharge the solder balls 24 onto the mask 20. The oscillation structure will be described in detail. The connection member 72 is attached to an oscillation frame 70. An oscillator 65 is provided at the oscillation frame 70 so that the solder ball shaking and discharging unit 7 is oscillated in the front and back directions of the travelling direction of the solder ball shaking and discharging unit 7 at a high frequency of, for example, about 220 to 250 Hz. Further, a slider 67 is provided at an upper portion of the oscillation frame 70. The slider 67M is attached to a linear guide 67R provided at the head attachment frame 71 provided above the oscillation frame. A cam 66 is provided at one end of the oscillation frame 70, and is rotated and driven by a camshaft driving motor 68 provided at the head attachment frame 71, so that the oscillation frame 70 is vibrated in the horizontal direction (towards the linear guide) at a frequency of, for example, about 1 to 10 Hz which is lower than the above-described frequency of the oscillator 65.

As described above, by providing two different oscillation units, the frequencies at which the solder ball shaking and discharging unit 7 is oscillated can be selected in a wide range, and the solder balls to be shaken and discharged by oscillation from the wire member 62 in a semi-spiral shape or a convex shape which is provided so as to cover the solder ball shaking and discharging port 84 can be effectively fed to the surface of the mask from the solder ball feeding unit 64.

Further, the solder ball shaking and discharging unit 7 has a so-called sealing-type head structure in which when the wire member 62 in a semi-spiral shape or a convex shape and the solder ball loading members 63 provided at the solder ball feeding unit 64 are brought into contact with the mask 20, a sealed state is formed by the solder ball outer wall 73. This configuration prevents the solder balls 24 from being oxidized by the air entering the inside of the solder ball feeding unit 64.

As described above, by introducing a nitrogen gas into the inside of the head from nitrogen gas feeding ports 77-1 and 77-2, the oxidization of the solder balls 24 can be prevented and connection defects of the solder balls 24 can be reduced, as the sealing-type structure. Further, a valve (not shown) is provided at the solder ball shaking and discharging port 84 of the solder ball feeding unit 64 to prevent the extra solder balls 24 from being dropped into the wire member 62 in a semi-spiral shape or a convex shape. For example, this valve is opened and closed by rotating a cover state (shutter) with a damper mechanism by 90 degrees.

FIG. 5 shows an enlarged view of a part of the solder ball shaking and discharging unit 7. A state in which the solder balls 24 are printed will be described in detail using FIG. 5.

In FIG. 5, a flux 22 is preliminarily printed at an electrode portion 23 on the substrate 21. In addition, minute projections 20a are provided on the rear surface side of the mask 20 near the opening area 94 to prevent the mask 20 from being directly brought into contact with the flux. In place of the minute projections 20a, minute steps such as films may be provided. Further, as shown in FIG. 5, the wire member 62 in a semi-spiral shape or a convex shape is attached near the solder ball shaking and discharging port 84 of the solder ball feeding unit 64 so as to cover the solder ball shaking and discharging port 84.

The wire member 62 in a semi-spiral shape or a convex shape is brought into contact with the mask 20 in a slightly deformed state because the solder ball shaking and discharging unit 7 is pressed by the vertically-moving mechanism 4 to the extent that the solder ball shaking and discharging unit 7 is brought into contact with the mask 20 with predetermined pressing force. Here, the slightly deformed state of the wire member 62 in a semi-spiral shape or a convex shape is referred to as a state of a substantially spiral shape (or a substantially semicircular shape). It is obvious that the state of a substantially spiral shape (or a substantially semicircular shape) is determined in such a manner that the solder ball printing apparatus of the present invention is experimentally operated in advance, the pressing force is adjusted so as to substantially uniformly shake and discharge the solder balls 24 from the solder ball feeding unit 64 onto the mask 20, and the oscillation frequency is selected.

Next, there will be described an operation of substantially uniformly shaking and discharging the solder balls 24 from the solder ball feeding unit 64 onto the mask 20. In the wire member 62 in a semi-spiral shape or a convex shape provided near the solder ball shaking and discharging port 84 of the solder ball feeding unit 64, a space in a substantially spiral shape (or a substantially semicircular shape) is formed in the vertical direction, and the rotational force of the solder balls 24 is generated in the space in accordance with the traveling directions of the head as shown in the drawing. The rotational force of the solder balls 24 is generated by frictional force between the solder balls 24 and the wire member 62 and between the solder balls 24 and the mask 20. However, the vibration operation for oscillating the solder ball shaking and discharging unit 7 efficiently generates the rotational force as described above. Further, the oscillator 65 shown in FIG. 1 is advantageous in that minor vibration is applied to the balls, the dispersion of the balls and adhesion between the balls by the van der Waals force are avoided, and the solder balls 24 are efficiently shaken and discharged onto the mask 20. Accordingly, the solder balls 24 are dispersed, and one solder ball 24 is fed into one opening area 94 of the mask.

Further, the solder ball loading members 63-1 and 63-2 provided in the front and rear of the wire member 62 in a semi-spiral shape or a convex shape receive the solder balls 24 which are not loaded into the opening area 94 of the mask through the wire member 62 in a semi-spiral shape or a convex shape among those shaken and discharged from the solder ball shaking and discharging port 84, and shake and feed the solder balls 24 into a portion of the opening area 94 of the mask 20 where no solder balls are fed while applying rotational force to the solder balls 24, as similar to the wire member 62 in a semi-spiral shape or a convex shape.

It should be noted that the solder ball loading members 63 are configured by the same wire member as the wire member 62 in a semi-spiral shape or a convex shape provided at the solder ball shaking and discharging port 84. It should be noted that although the detail of the wire member 62 in a semi-spiral shape or a convex shape and the solder ball loading members 63 will be described later, each of intervals of wire members configuring the wire member 62 in a semi-spiral shape or a convex shape is smaller than the diameter of the solder ball 24 to be used by about 5 μm. As described above, setting the respective intervals smaller than the diameter of the solder ball 24 to be used by about 5 μm is advantageous in preventing many solder balls from being dropped onto the mask at a time, and the solder balls 24 can be uniformly shaken and dropped onto the mask 20. It should be noted that even if each of the intervals of the wire members configuring the wire member 62 in a semi-spiral shape or a convex shape is smaller than the diameter of the solder balls 24 by about 5 μm, the rotation of the solder balls 24 allows the solder balls 24 to slip through the intervals of the wire members and the solder balls are fed onto the mask 20.

Next, the embodiment of the solder ball printing apparatus will be described in more detail using FIG. 2. As shown in FIG. 2A, the solder ball printing apparatus 1 includes a printing table 10 on which the substrate 21 for printing the solder balls 24 is placed and a driving unit 11 for driving the printing table 10 to be vertically moved. The substrate 21 placed on the printing table 10 and the surface of the mask 20 are aligned using a camera 15 by driving an XY table (not shown) that is a horizontally-moving mechanism provided under the printing table 10. Specifically, the camera 15 images, for example, an alignment mark provided at the substrate 21 and an alignment mark provided at the mask 20 at the same time, and the XY table is moved so as to match the marks of the images for alignment.

Thereafter, the camera 15 for alignment is withdrawn, and the printing table 10 is lifted to allow the surface of the mask 20 provided on the upper portion of the table to be brought into contact with the surface of the substrate 21 as shown in FIG. 2B. Then, the head vertically-driving mechanism 4 is driven to allow the wire member 62 in a semi-spiral shape or a convex shape and the solder ball loading members 63 for feeding the solder balls to be brought into contact with the surface of the mask by vertically moving the ball feeding head 3. As described above, the pressing force is generated at the wire member 62 and the solder ball loading members 63 by the head vertically-driving mechanism 4, and a so-called printing pressure by which the solder balls 24 are pressed into the opening area 94 of the mask is accordingly generated.

Then, the ball screw 2b is rotated by driving the head driving unit 2g to move the solder ball feeding head 3 in the horizontal directions (arrow directions). When the solder ball feeding head 3 is being moved, the solder ball shaking and discharging unit 7 is oscillated in the horizontal direction (head moving direction) by the oscillator 65. At the same time, the cam 66 is also oscillated in the horizontal direction by driving and rotating the cam shaft driving motor 68, and the solder balls 24 in the wire member 62 in a semi-spiral shape or a convex shape are effectively shaken and discharged.

It should be noted that although it is described in the embodiment that the oscillator 65 and the cam 66 are driven at the same time to shake and discharge the solder balls 24, the solder balls may be shaken and discharged by driving one of the oscillator 65 and the cam 66. Further, at the same time as shaking and discharging of the solder balls, the solder balls are loaded into the opening area provided at the mask 20 by the solder ball loading members 63 which are provided in the moving directions of the solder ball feeding head 3 while sandwiching the wire member 62 in a semi-spiral shape or a convex shape of the solder ball feeding unit 64.

When loading the solder balls, the solder ball rotating and collecting mechanisms 75-1 and 75-2 disposed near the loading members 63-1 and 63-2 are rotated and driven in the arrow directions to collect the solder balls remaining on the mask near the solder ball feeding unit 64. Thus, the extra solder balls are prevented from being dropped outside the solder ball shaking and discharging unit 7. Further, a cleaning mechanism 45 for cleaning the rear surface of the mask is provided at a camera moving frame in the apparatus. The cleaning mechanism 45 cleans the mask while moving in the horizontal direction as similar to the camera 15. The cleaning mechanism 45 allows a sucking nozzle via a roll-to-roll clean wiper to be brought into contact with and moved to the rear surface of the mask for cleaning the mask.

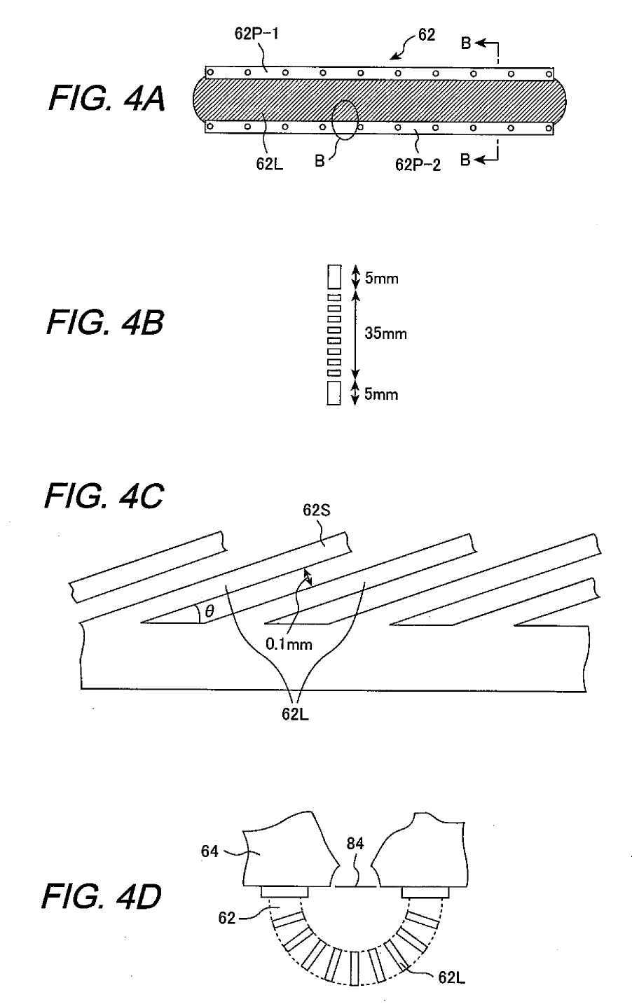

Next, the wire member 62 in a semi-spiral shape or a convex shape provided near the solder ball shaking and discharging port 84 of the solder ball shaking and discharging unit 7 will be described in detail using FIG. 4. For the wire member 62 in a semi-spiral shape or a convex shape, for example, the wire member 62 in a semi-spiral shape will be described in detail in FIG. 4. However, it is obvious that the configuration similar to this may be configured by the wire member in a convex shape. Further, the wire member 62 in a semi-spiral shape or a convex shape will be described in FIG. 4. However, since the solder ball loading members 63 can be configured similar to the wire member 62 in a semi-spiral shape or a convex shape, the explanation of the solder ball loading members 63 will be omitted.

FIG. 4A is a plan view for showing a state before the wire member 62 in a semi-spiral shape is attached to the solder ball feeding unit 64, FIG. 4B is a diagram for showing a cross section taken along the line B-B in FIG. 4A, and FIG. 4C is an enlarged view of a portion B in FIG. 4A. FIG. 4D is a cross-sectional view in a state where the wire member 62 in a semi-spiral shape is bent in a convex shape, and is attached near the solder ball shaking and discharging port 84 of the solder ball feeding unit 64.

In FIG. 4A, the wire member 62 in a semi-spiral shape includes two attachment portions 62P-1 and 622-2 (the width of each attachment portion is about 5 mm, and the attachment portions 622-1 and 62P-2 are collectively referred to as attachment portions 62P in some cases) which are provided in parallel at a predetermined interval (about 35 mm in the embodiment) and a plurality of wire members 62L with predetermined angles relative to the attachment portions 622 between the attachment portions 62P, as shown in the drawing. In more detail, the wire member 62 in a semi-spiral shape includes the attachment portions 62P and the plurality of wire members 62L with predetermined angles A of, for example, about 5 to 35 degrees, preferably, about 10 degrees relative to the attachment portions 62P, as shown in FIG. 4C. The thickness of each wire member 62L is, for example, about 0.1 mm, and the wire members 62L are formed at predetermined intervals 62S of, for example, about 0.1 mm to 0.3 mm. It should be noted that each dimension shown in the embodiment is an example, and the embodiment is not limited to this. For example, the width of each predetermined interval 62S of about 0.1 mm is changed due to the diameter of the solder ball in some cases. However, it has been experimentally confirmed that the width of each predetermined interval 62S of about 0.1 mm can be used for the solder ball with a diameter of 20 to 80 μm. Further, the embodiment is described using the wire member 62 in a semi-spiral shape. This is because if the planar wire member 62 in a semi-spiral shape as shown in FIG. 4A is bent to be attached to the solder ball feeding unit 64 as shown in FIG. 4D, the wire members 62L become a semi-spiral shape. However, the embodiment is not limited to the wire member 62 in a semi-spiral shape, but the wire member 62 in a convex shape may be used. Thus, the wire member 62 in a convex shape includes the wire member 62 in a semi-spiral shape.

Next, a producing method of the wire member 62 in a semi-spiral shape will be described. The wire member 62 in a semi-spiral shape is formed in a shape as shown in FIG. 4A by etching a steel plate with a thickness of 0.1 mm through a mask in a predetermined shape.

Accordingly, the length of the wire member 62 in a semi-spiral shape corresponds to the width of the solder ball feeding head 3. The wire member 62 in a semi-spiral shape is attached across the solder ball shaking and discharging port 84 of the solder ball feeding unit 7. Specifically, the wire member 62 is attached in such a shape that the upper half portion of a spiral coil is cut off in the vertical direction of the solder ball feeding head. The wire member 62 is formed while being bent as shown in FIG. 4D, as an example.

Further, the head attachment frame 71 can be vertically moved by a motor 4 as a driving unit. It should be noted that although it is described in the embodiment that the head attachment frame 71 is vertically driven by the motor 4, a pneumatic cylinder may be used in place of the motor 4.

Further, the solder ball rotating and collecting mechanisms 75-1 and 75-2 (rotational squeegees) for collecting the solder balls on the front end side and the rear end side in the moving direction of the solder ball shaking and discharging unit 7 are provided inside the head outer wall 73.

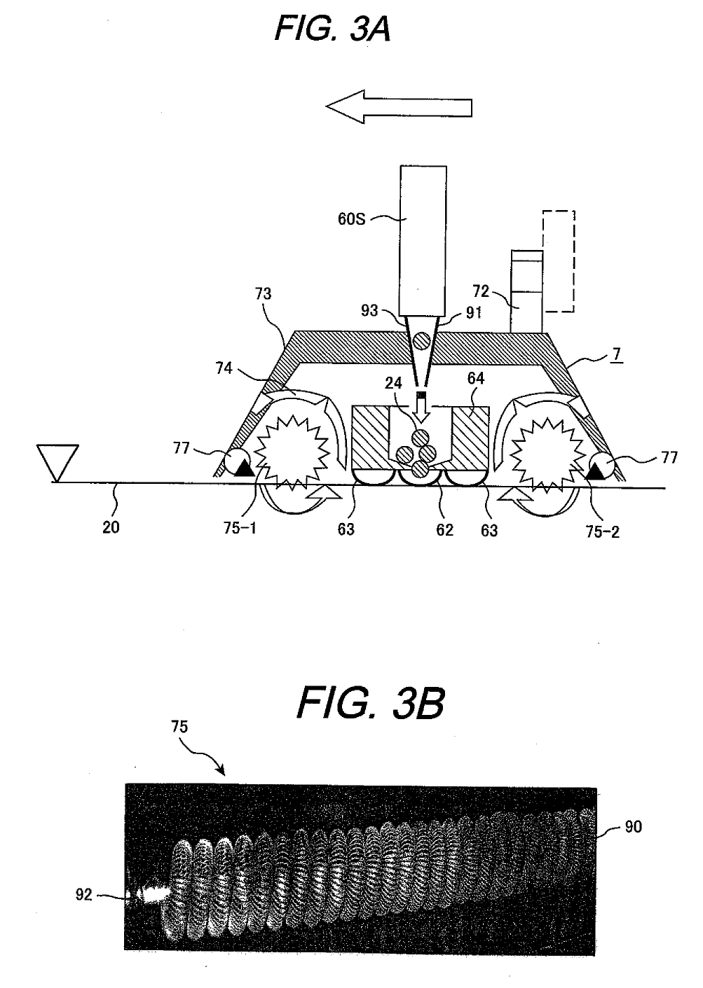

The solder ball rotating and collecting mechanisms 75-1 and 75-2 are rotated in the directions as shown by the arrows. Specifically, the solder ball rotating and collecting mechanisms 75-1 and 75-2 are configured to be rotated in the directions opposed to each other. The solder ball rotating and collecting mechanism 75 has a configuration in which a wire member 90 is formed in a spiral shape and a cylindrical shape at a scratching unit and is attached in multiple stages in the longitudinal direction of a rotational shaft as shown in FIG. 3B. The solder ball rotating and collecting mechanisms 75 are configured in such a manner that in the case where the solder balls 24 are shaken and discharged onto the mask 20, movement of the solder ball shaking and discharging unit 7 in the arrow direction rotates and drives the solder ball rotating and collecting mechanisms 75 to accumulate the solder balls 24 dispersed around the solder ball feeding unit 64 at a lower portion of the solder ball feeding unit 64, and the solder balls 24 are reliably loaded into the opening area 94 of the mask.

Further, by attaching the squeegee covers 74 covering the outer circumferences of the solder ball rotating and collecting mechanisms 75 to the inside of the head outer wall 73, the extra solder balls are scratched and collected towards the solder ball loading members 63, and the solder balls are prevented from scattering around the solder ball feeding unit 64.

### Second Embodiment

Next, another embodiment of the solder ball printing apparatus according to the present invention will be described using FIG. 3. FIG. 3 are diagrams, each showing a configuration of a solder ball shaking and discharging unit 7 in another embodiment of the solder ball shaking and discharging unit 7 shown in FIG. 1. It should be noted that the same reference numerals are given to the same units as those in FIG. 1A. The configuration of the solder ball shaking and discharging unit 7 according to the embodiment shown in FIG. 3 is different from that of the solder ball shaking and discharging unit 7 according to the first embodiment shown in FIG. 1 in that a feeding port of a solder ball reservoir unit 60S is inserted into an opening area 91 provided at the head outer wall 73, and the entire solder ball reservoir unit 60S can be moved in the direction orthogonal to the longitudinal direction of the head, namely, the direction shown by the arrow. For example, in place of the solder ball reservoir unit 60 shown in FIG. 1, the solder ball reservoir unit 60S is attached to the solder ball feeding table 61 and the linear driving unit 76 can be moved in the longitudinal direction, so that a moving mechanism can be realized. Further, although not shown in the drawing, the solder ball feeding table to which the solder ball reservoir unit 60S is attached can be vertically moved nearer the head outer wall 73 by the linear driving unit 76 as compared to the solder ball feeding table 61 shown in FIG. 1. In such a configuration, when the solder balls 24 are fed to the solder ball feeding unit 64 from the solder ball reservoir unit 60S, the solder balls 24 can be prevented from being spread around and can be reliably fed to the solder ball feeding unit 64, as compared to the apparatus of FIG. 1 according to the first embodiment. Further, in such a configuration, a period of time when the solder balls 24 are exposed to the atmosphere is shortened and oxidization is prevented.

Further, FIG. 3B shows an exterior appearance of the solder ball rotating and collecting mechanisms 75-1 and 75-2 (which are collectively referred to as the solder ball rotating and collecting mechanisms 75 in some cases). As shown in the drawing, a scratching unit 90 in a disk shape made of a wire member is attached to a rotational shaft 92 in a spiral manner in multiple stages. Portions of the scratching unit 90 in a disk shape to be brought into contact with the mask 20 are attached while being inclined by predetermined angles θ of, for example, about 5 to 35 degrees relative to the direction orthogonal to the moving direction of the solder ball shaking and discharging unit 7. It should be noted that the configuration of the solder ball rotating and collecting mechanism 75 shown in FIG. 3B is substantially the same as that shown in FIG. 1. Further, the solder ball reservoir unit 60S configured by a cylindrical container is shown in the drawing. In addition, the tip end of the solder ball reservoir unit 60S is formed to be long as an inversed conical guide 93, and can be inserted into the opening area 91 of the head outer wall 73. In such a configuration, the solder balls 24 can be prevented from being spread around surrounding areas from the solder ball reservoir unit 60S, and can be efficiently fed to the solder ball feeding unit 64.

However, the present invention is not limited to this structure. In place of the solder ball reservoir unit 60S, the following configuration may be employed. A disk-shape solder ball reception portion provided with a solder ball feeding port is provided at the opening area 91 of the head outer wall 73, and measured solder balls are placed on the solder ball reception portion. Thereafter, the solder ball reception portion is moved in the longitudinal direction relative to the moving direction of the solder ball shaking and discharging unit 7, so that a predetermined amount of solder balls can be fed to the solder ball feeding unit 64. Further, the opening area 91 of the head outer wall 73 provided in accordance with the opening area 83 of the solder ball feeding unit 64 is covered with a rubber member halved in the longitudinal direction of the solder ball shaking and discharging unit 7, and the inversed conical guide 93 of the solder ball reservoir unit 60S can be inserted from the halved portion.

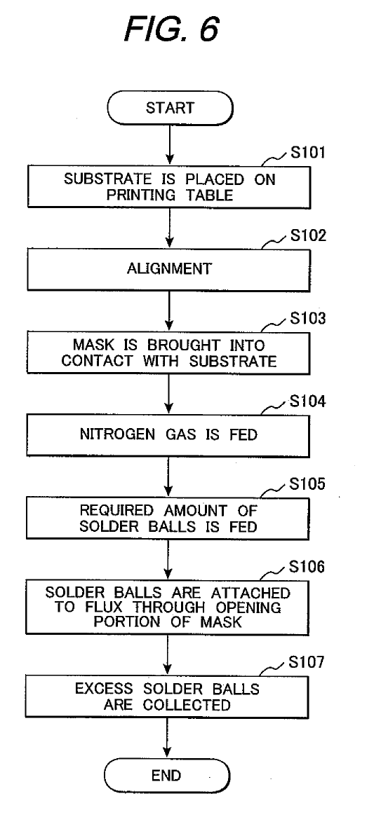

Next, a series of operations of printing the solder balls will be described using FIG. 6.

In the first place, the substrate 21, for example, a semiconductor wafer 21 (which is referred to as the substrate 21 in the following description) on which a flux 22 is printed at the electrode portion 23 is carried into the solder ball printing apparatus to be placed on the printing table 10 (step S101). A plurality of adsorption ports for feeding negative pressures are provided at the printing table 10, and the substrate 21 is retained so as not to move on the surface of the printing table by feeding negative pressures to the printing table 10.

Next, the alignment mark provided at the surface of the substrate 21 and the alignment mark provided at the mask 20 are imaged using the camera 15 for alignment. The imaged data are transmitted to a controlling unit (not shown) where image processing is performed to obtain misalignment. On the basis of the result, the printing table is moved by the horizontally-moving mechanism (not shown) in the direction where the misalignment is corrected (step S102).

When the alignment is completed, the printing table 10 is lifted, and the printing surface of the wafer 21 is brought into contact with the rear surface of the mask 20 (step S103).

Next, the solder ball feeding head 3 is horizontally moved to a print starting position, and then, is lowered on the surface of the mask, so that a predetermined printing pressure (pressing force) is applied to the surface of the mask. Next, a nitrogen gas is fed into the inside of the head from the nitrogen gas feeding ports 77, and the inside of the head becomes a nitrogen atmosphere (step S104). Thereafter, the amount of solder balls in the solder ball feeding unit 64 is checked. In the case where the amount is not enough to be required for printing, the solder ball reservoir unit 60 is operated to feed the required amount of solder balls to the solder ball feeding unit 64 (step S105).

Thereafter, the oscillator 65 and the cam shaft driving motor 68 are driven to feed the solder balls 24 accommodated in the solder ball feeding unit 64 onto the surface of the mask from the solder ball shaking and discharging port 84 provided at the solder ball feeding unit 64 through the wire member 62 in a convex shape.

While the solder ball feeding head 3 is moved in the horizontal direction, the solder balls 24 are pressed into the opening area 94 of the mask by spring action of the wire member in a convex shape of the solder ball loading members 63, and the solder balls 24 are attached to the flux 22 on the substrate 21 (step S106). At this time, by rotating the solder ball rotating and collecting mechanical units 75, the solder balls 24 which are not pressed into the opening area 94 of the mask are collected by the solder ball rotating and collecting mechanical units 75, and are prevented from being leaked outside from the inside of the solder ball shaking and discharging unit 7.

When the movement of the solder ball feeding head 3 on the surface of the mask is finished, the solder ball feeding head 3 stops once to switch a switching valve provided at a nitrogen gas feeding system for feeding a nitrogen gas into the nitrogen gas feeding ports 77 provided in the solder ball feeding head, and the valve is connected to a negative pressure feeding system. Accordingly, the extra solder balls 24 are collected by feeding negative pressures to the nitrogen gas feeding ports 77 in place of a nitrogen gas (step S107). Next, the solder ball feeding head 3 is lifted so as to be apart from the surface of the mask 20, and then, is returned to its original position (home position). It should be noted that although it is described in the embodiment that the extra solder balls are collected by feeding negative pressures to the nitrogen gas feeding ports, the solder balls collected on one side of the surface of the mask may be manually collected.

Next, the printing table 10 is lowered, and the mask is apart from the printing table. A printed state of the printed substrate 21 is imaged by the camera 15 to check the presence or absence of defects. If defects are present, the substrate is carried to a repairing unit to repair the defect portions. The substrate 21 is carried to a reflowing unit after the defect portions are repaired, and the solder balls 24 are melted to be fixed to the electrode portion 23.

The steps of the printing method of solder balls have been roughly described above, and the repairing method of the defect portions and the reflowing method after the defect portions are repaired after the step S107 have been well known from the past. Thus, the detailed explanations thereof are omitted in this specification.

As described above, it is possible to reliably feed the solder balls with minute diameters onto the flux of the substrate one by one from the opening area of the mask by using the solder ball printing apparatus of the present invention.

The embodiment has been described in detail above. However, it is obvious that the present invention is not limited to the embodiment of the solder ball printing apparatus and the solder ball printing method described herein, but can be easily applied to another solder ball printing apparatus and another solder ball printing method.

What is claimed is:

1. A solder ball printing apparatus which prints solder balls on a substrate and an electrode on the substrate through a mask, the apparatus comprising:
a solder ball reservoir unit which reserves the solder balls;
a solder ball shaking and discharging unit which is located under the solder ball reservoir unit, receives a predetermined amount of solder balls from the solder ball reservoir unit, and feeds the received solder balls onto a surface of the mask located on the substrate;
a moving mechanical unit which moves the solder ball shaking and discharging unit along the substrate; and
an oscillation unit which applies predetermined oscillation to the solder ball shaking and discharging unit, wherein
the solder ball shaking and discharging unit includes a solder ball feeding unit for receiving the solder balls from the solder ball reservoir unit, a wire member in a convex shape which is attached so as to surround a solder ball shaking and discharging port of the solder ball feeding unit and in which a plurality of wire members are arranged at predetermined intervals, and solder ball loading members, each of which is located in the front and rear of the wire member in a convex shape to load the solder balls into an opening area of the mask.

2. The solder ball printing apparatus according to claim 1, wherein
the solder ball shaking and discharging unit further includes solder ball rotating and collecting mechanisms, each of which is located in the front and rear of the solder ball loading members and collects the solder balls which are dispersed without being loaded by the solder ball loading members near the solder ball loading members.

3. The solder ball printing apparatus according to claim 2, wherein
the solder ball shaking and discharging unit is provided with a head outer wall so as to cover the solder ball feeding unit, the solder ball loading members, and the solder ball rotating and collecting mechanisms, and is formed as a sealing-type head structure.

4. The solder ball printing apparatus according to claim 3, wherein
squeegee covers are further provided on the inner side of the head outer wall so as to cover the solder ball rotating and collecting mechanisms.

5. The solder ball printing apparatus according to claim 1, wherein
the moving mechanical unit further includes a vertically-driving mechanism for vertically moving the solder ball shaking and discharging unit, applies pressing force to press the wire member in a convex shape and the solder ball loading members provided at the solder ball shaking and discharging unit to the surface of the mask with the vertically-driving mechanism, and allows the wire member in a convex shape and the solder ball loading members to be brought into contact with the surface of the mask with predetermined pressing force in the moving direction of the solder ball shaking and discharging unit.

6. The solder ball printing apparatus according to claim 1, wherein
the wire member in a convex shape and wire members configuring the solder ball loading members are configured by the plurality of wire members at predetermined intervals, the wire member is a steel plate with a thickness of 0.05 to 0.1 mm and a width of 0.1 mm, the intervals of the wire members are 0.1 mm to 0.3 mm, and the wire members are provided while being inclined at angles of about 5 to 35 degrees relative to the direction orthogonal to the travelling direction of the solder ball shaking and discharging unit.

7. The solder ball printing apparatus according to claim 6, wherein
the plurality of wire members of the solder ball loading members provided at the solder ball shaking and discharging unit are provided in such a manner that the inclined directions thereof are opposed to each other.

8. The solder ball printing apparatus according to claim 1, further comprising: a printing table for fixing the substrate; a camera with two upper and lower viewing fields for recognizing an electrode pattern on the substrate on the printing table and an electrode pattern of the mask; a driving apparatus which drives and aligns the printing table on the basis of the result recognized by the camera with two viewing fields; and a driving mechanism for lifting the printing table to allow the substrate to be brought into contact with the mask.

9. A solder ball printing method in a solder ball printing apparatus which prints solder balls retained in a solder ball reservoir unit on a substrate and an electrode on the substrate through a mask, the method comprising:
a step of receiving a predetermined amount of solder balls from the solder ball reservoir unit and feeding the received solder balls onto a surface of the mask;
a solder ball dispersing step of dispersing the solder balls fed from the solder ball reservoir unit into an opening area of the surface of the mask;
a solder ball loading step of loading the solder balls dispersed in the solder ball dispersing step into the opening area of the surface of the mask; and
a step of collecting the solder balls which are dispersed without being loaded in the solder ball loading step.
